(19) United States
(12) Patent Application Publication
(10) Pub. No.: US 2026/0335694 A1
(43) Pub. Date: Oct. 29, 2026

(54) STANDPIPE DRILL AND TRAINING APPARATUS

(71) Applicant: FIRE DEPARTMENT CONNECTIONS LLC, Brooklyn, NY (US)

(72) Inventor: Michael Kinnane, Brooklyn, NY (US)

(21) Appl. No.: 19/658,478

(22) Filed: Apr. 25, 2026

Related U.S. Application Data
(60) Provisional application No. 63/796,281, filed on Apr. 28, 2025.

(51) Int. Cl. A62C 99/00

(52) U.S. Cl. CPC A62C 99/0081

(57) ABSTRACT

A standpipe training apparatus comprises a support base, vertical pipe system, water supply inlet, and hose connection assembly. The support base is configured to hold water for support. The vertical pipe system is connected to the support base. The water supply inlet is connected to the vertical pipe system, and emulates a fire department connection to a standpipe system, and is configured for connection to a fire hose to pump pressured water into the vertical pipe system. The hose connection assembly is connected to the vertical pipe system, and emulates a hose connection assembly of a standpipe system. The hose connection assembly comprises a control valve that connects to a fire hose and comprises a manual valve actuator for manually controlling an amount of pressurized water in the vertical pipe system which is output from the control valve into a fire hose connected to the hose connection assembly.

### CROSS-REFERENCE TO RELATED APPLICATION

This application claims the benefit of, and priority to, U.S. Provisional Application Ser. No. 63/796,281, filed on Apr. 28, 2025, the disclosure of which is incorporated herein by reference.

### BACKGROUND

The present disclosure relates generally to training devices and methods to assist in training firefighters to utilize standpipe systems of buildings. In general, standpipe systems are essential components of fire protection in buildings, which are designed to provide reliable delivery of water to hard-to-reach areas while reducing the need for extensive hose deployment. A standpipe system consists of a network of piping that connects to a water source and comprises multiple outlets, allowing firefighters or trained personnel to access water quickly and efficiently. Essentially, a standpipe system is an extension of a fire hydrant system, and effectively provides indoor fire hydrants within a building to provide a pre-piped water source for manual fire suppression.

### SUMMARY

Embodiments of the disclosure include standpipe training devices (or standpipe training props) which emulate standpipe systems, and which are utilized to drill and train firefighters for using standpipe systems.

For example, an exemplary embodiment includes an apparatus which comprises a support base, a vertical pipe system, a water supply inlet, and a hose connection assembly. The support base is configured to hold water to support the apparatus. The vertical pipe system is connected to the support base. The water supply inlet is connected to the vertical pipe system. The water supply inlet emulates a fire department connection to a standpipe system, and is configured for connection to a fire hose to pump pressured water into the vertical pipe system. The hose connection assembly is connected to the vertical pipe system. The hose connection assembly emulates a hose connection assembly of a standpipe system. The hose connection assembly comprises a control valve that is configured for connection to a fire hose, and which comprises a manual valve actuator for manually controlling an amount of pressurized water in the vertical pipe system which is output from the control valve into a fire hose connected to the hose connection assembly.

Another exemplary embodiment includes a system which comprises a standpipe drill and training apparatus, and a water pump to pump pressurized water from a water source to the standpipe drill and training apparatus. The standpipe drill and training apparatus comprises: a support base configured to configured to hold water to support the apparatus; a vertical pipe system connected to the support base; a water supply inlet connected to the vertical pipe system, which emulates a fire department connection to a standpipe system, and which is configured for connection to a fire hose to inject the pressurized water into the vertical pipe system; and a hose connection assembly connected to the vertical pipe system, which emulates a hose connection assembly of a standpipe system, and which comprises a control valve that is configured for connection to a fire hose and which comprises a manual valve actuator for manually controlling an amount of pressurized water in the vertical pipe system which is output from the control valve into a fire hose connected to the hose connection assembly.

Other embodiments will be described in the following detailed description of embodiments, which is to be read in conjunction with the accompanying figures.

### BRIEF DESCRIPTION OF DRAWINGS

FIG. 1 is a perspective view of a standpipe training apparatus, according to an exemplary embodiment of the disclosure.

FIG. 2A is a schematic side-view of a standpipe training apparatus, according to another exemplary embodiment of the disclosure.

FIG. 2B is a schematic plan view of a support base of the standpipe training apparatus, taken along line 2B-2B in FIG. 2A, according to an exemplary embodiment of the disclosure.

FIG. 2C is a schematic cross-sectional side view of the support base of the standpipe training apparatus, taken along line 2C-2C in FIG. 2B, according to an exemplary embodiment of the disclosure.

### DETAILED DESCRIPTION OF EXEMPLARY EMBODIMENTS

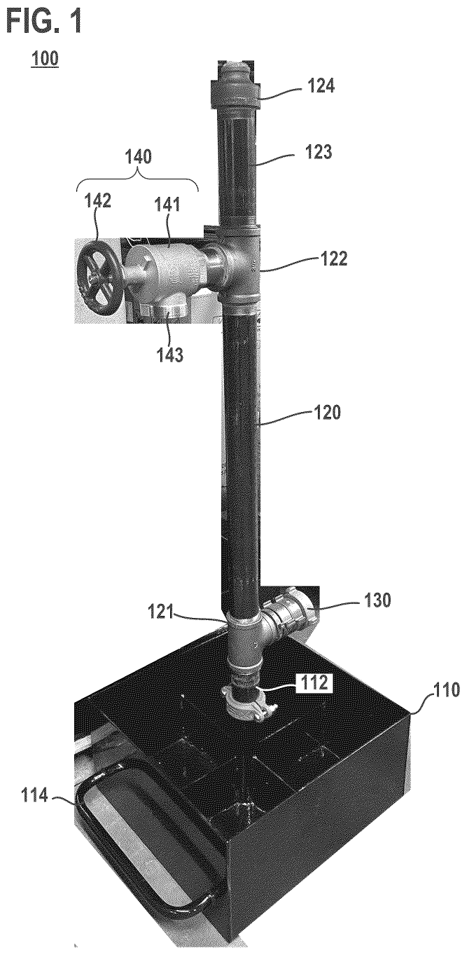

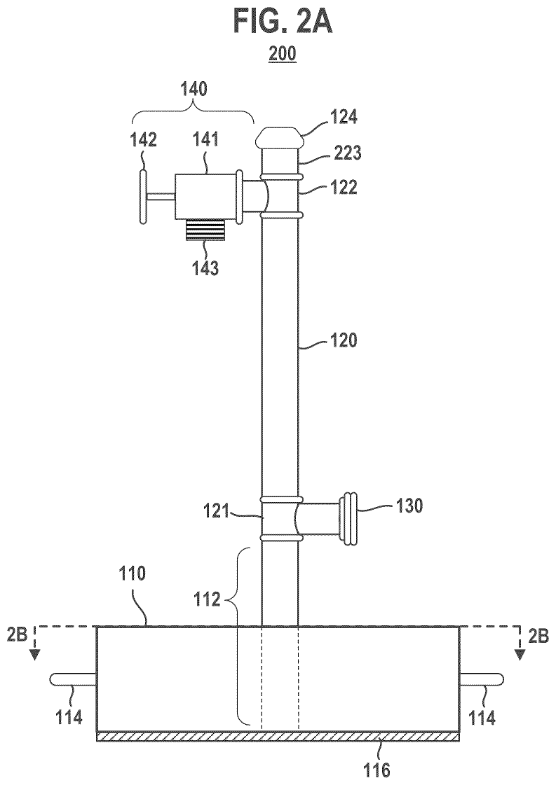

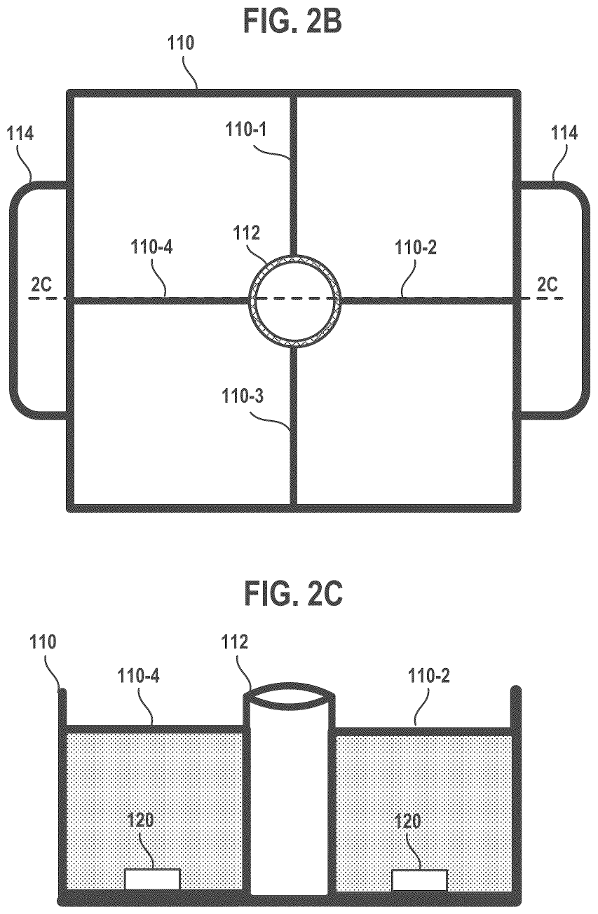

Exemplary embodiments of the disclosure will now be described in further detail with regard to standpipe training devices (or standpipe training props) which emulate standpipe systems and which are utilized to drill and train firefighters for using standpipe systems in actual firefighting operations. For example, FIG. 1 is a perspective view of a standpipe training apparatus 100, according to an exemplary embodiment of the disclosure. The standpipe training apparatus 100 comprises a support base 110 (or support basin 100), a vertical standpipe 120, a first T-coupler 121, a second T-coupler 122, an optional air chamber 123, pipe cap 124, a water supply inlet and hose coupler 130, and a hose connection assembly 140. The support base 110 comprises a pipe riser 112 (or first vertical pipe section), and support handles 114 (and other components as discussed below in conjunction with FIGS. 2A and 2B). The hose connection assembly 140 comprises a control valve 141, a valve handwheel 142 (generally, control valve actuator), and a hose connector 143 (or standpipe output). The first T-coupler 121 is configured to connect the vertical standpipe 120 to the piper riser 112 of the support base 110, and to provide an inlet for injecting pressurized water into the vertical standpipe 120 via the water supply inlet and hose coupler 130. The second T-coupler 122 is configured to connect the hose connection assembly 140 to the vertical standpipe 120, and to connect the vertical standpipe 120 to the optional air chamber 123.

The water supply inlet and hose coupler 130 provides a connection point to connect a water hose that supplies pressurized water which is pumped to the standpipe training apparatus 100 using a pump and water supply source, such as a pump from a fire engine. Indeed, fire engines (or pumpers) are designed to store and pump water. A fire engine can include an onboard water tank which holds 500 -1,500 gallons of water (or more), and includes a powerful pump that is capable of discharging water at high pressure, wherein the initial onboard water supply allows firefighters to begin extinguishing a fire immediately while establishing a sustainable water source, such as a fire hydrant. The vertical standpipe 120 delivers the pressurized water to the hose connection assembly 140. The vertical standpipe 120 emulates a main vertical pipe that runs through a building to supply water to various hose connections disposed at different locations in the building. The hose connector 143 (standpipe outlet) is configured to connect to a standard hose coupling on the end of a fire hose. The valve handwheel 142 serves as a valve actuator, which is turned clockwise or counterclockwise to manually regulate the opening and closing of the control valve 141. The air chamber 123 (or water hammer arrestor), is a vertical pipe section installed near (e.g., above) the control valve 141 to absorb shock waves caused by a water hammering effect which results from, e.g., turning off the control valve 141, or a sudden change in water flow.

In some embodiments, the support base 110 is structurally configured as a rectangular-shaped basin which has a relatively large volume that is filled with water to provide stability and prevent the standpipe training apparatus 100 from possibly tipping over or sliding over a floor when pressurized water is injected into the vertical standpipe 120 of the standpipe training apparatus 100 via a fire hose connected to the water supply inlet and hose coupler 130, and output to a fire house that is connected to the hose connection assembly 140. For example, in an exemplary non-limiting embodiment, the support base 110 can have a square-shaped footprint area (width x length) of 24 inches by 24 inches, and a height of 12 inches. In this regard, when the support base 110 is filled with water, a total weight of the standpipe training apparatus 100 including the water in the support base 110 can exceed 300 pounds.

FIGS. 2A, 2B, and 2C schematically illustrate a standpipe training apparatus 200, according to another exemplary embodiment of the disclosure, wherein FIG. 2A is a schematic side-view of the standpipe training apparatus 200, FIG. 2B is a schematic plan view of a support base of the standpipe training apparatus 200 taken along line 2B-2B in FIG. 2A, and FIG. 2C is a schematic cross-sectional side view of the support base of the standpipe training apparatus 200, taken along line 2C-2C in FIG. 2B, according to an exemplary embodiment of the disclosure. The standpipe training apparatus 200 is similar to the standpipe training apparatus 100 of FIG. 1, except that the standpipe training apparatus 200 implements a short pipe section 223 in place of the air chamber 123. In other embodiments, the T-coupler 122, the short pipe section 223, and cap 124 can be replaced using a 90-degree elbow coupler to connect the vertical standpipe 120 and the hose connection assembly 140. In addition, FIG. 2A illustrates an exemplary embodiment in which an outer bottom surface of the support base 110 further comprises a rubber pad 116 which serves as an anti-slip pad that provides further stability and prevents the standpipe training apparatus 200 from possibly sliding on the floor when pressurized water is injected into the vertical standpipe 120.

As schematically illustrated in FIG. 2B, a base of the piper riser 112 is welded to a bottom surface in the middle region of the support base 110, and the support base 110 comprises four baffles 110-1, 110-2, 110-3, and 110-4, each having one end welded to the pipe riser 112, and another end welded to a respective sidewall of the support base 110. The baffles 110-1, 110-2, 110-3, and 110-4 are implemented to provide structural support and integrity to the support base 110 and the vertical standpipe assembly. In some embodiments, each baffle 110-1, 110-2, 110-3, and 110-4 has a respective through-opening (e.g., cutout) at the bottom thereof to allow water to equalize throughout the entire support base 110, as schematically shown in FIG. 2C. In particular, FIG. 2C schematically illustrates side views of the baffles 110-2 and 110-4 with respective ends connected (via welding) to inner sidewalls of the support base 110 and the piper riser 112. In addition, FIG. 2C schematically illustrates openings 120 at the bottom edges of the baffles 110-2 and 110-4 (with similar openings at the bottom edges of the baffles 110-1 and 110-3) . With this configuration, water can be added to one of the four (4) sections of the support base 110 as defined by the baffles 110-1, 110-2, 110-3, and 110-4 (see FIG. 2B), and water will flow into the other sections of the support base 110 via water flow through the bottom openings 120.

It is to be noted that in an exemplary non-limiting embodiment, the pipe riser 112, the vertical standpipe 120, and the couplers and fittings of the vertical standpipe assembly can be implemented using 2½ inch metallic piping and 2½ inch threaded metallic fittings. In addition, the support base 110 can have a drain plug that allows water to drain from the support base 110. When the support base 110 is emptied of water, the standpipe training apparatus 100 and 200 can be manually moved using the support handles 114. It is to be further noted that the standpipe training apparatus 100 and 200 can be readily implemented using any suitable hose connection assembly 140 and hose coupling 130 with coupling connections that are adapted for use with corresponding types of fire hose couplers, adapters, fittings, etc., and which are used by various municipalities and fire departments to (i) enable the connection of a water supply hose to the water supply inlet and hose coupling 130 and (ii) enable the connection of a fire hose to the hose connection assembly 140. Moreover, while the standpipe training apparatus 100 and 200 are shown to have one hose connection assembly 140, the number of hose lengths being charged from the standpipe outlet can also be decreased or increased to allow for various functionality as well.

The exemplary standpipe training apparatus 100 and 200 provide a simulated standpipe system which allows firefighting units to drill and train for connecting hoses to a standpipe system and pumping water from, e.g., a fire engine pump, into the standpipe training apparatus 100 and 200 and operating the valve handwheel 142 of the control valve 141 to output pressurized water from a hose (or hoses) connected to the hose connection assembly 140. Advantageously, the standpipe training apparatus 100 and 200 not only assists in training a firefighter to make proper connections of hoses to a standpipe system, the standpipe training apparatus 100 and 200 also assists in drilling and training for the use a standpipe system that is charged with pressurized water. Again, the standpipe training apparatus 100 and 200 enables training a firefighter to pump water from a fire engine pump to the water supply inlet 130 via a first hose connected to the water supply inlet 130, and operate the valve handwheel 142 of the control valve 141 to output pressurized water from a hose (or hoses) connected to the hose connection assembly 140, simulating the firefighting evolution of a building's standpipe system.

The standpipe training apparatus 100 and 200 allows for various positions (e.g., officer, engine chauffer, etc.) in an engine company to drill on the specialized duties assigned to each position. For example, during training drill, the officer will supervise the entire operation. The engine chauffeur will stretch a hose to a fire hydrant or water source and charge the engine with sufficient water at an inlet on the fire engine. The chauffeur will then stretch a supply hose line to the standpipe training apparatus 100 and 200 and when ordered to do so, will charge the standpipe training apparatus 100 and 200 with an appropriate water pressure. A control position will connect any applicable pressure regulator or gauge to the hose connector 143 (standpipe outlet) and then connect a working hose line to the hose connection assembly 140. Then, nozzle and back up positions will connect their hose lengths to the working hose length, and then flake out, e.g., a three hose length stretch. The nozzle and back up firefighters will then proceed to operate and train with the pressurized hose line, with water flowing.

In particular, once the standpipe training apparatus 100 and 200 is charged with pressurized water from the fire engine, a control firefighter will be ordered to open the standpipe shutoff, and water will follow through the three hose length stretch. As the training drill proceeds, the water pressure supplied to the standpipe training apparatus 100 and 200 can be adjusted up or down, as necessary, by the chauffeur. The pressure of the water that is output from the standpipe training apparatus 100 and 200 into the firefighting hoses can be adjusted by the control position manually turning the valve handwheel 142 of the control valve 141.

Although exemplary embodiments of the present invention have been described herein with reference to the accompanying figures, it is to be understood that the invention is not limited to those precise embodiments, and that various other changes and modifications may be made therein by one skilled in the art without departing from the scope of the appended claims.

I claim:

1. An apparatus, comprising:
a support base configured to configured to hold water to support the apparatus;
a vertical pipe system connected to the support base;
a water supply inlet connected to the vertical pipe system, which emulates a fire department connection to a standpipe system, and which is configured for connection to a fire hose to pump pressured water into the vertical pipe system; and
a hose connection assembly connected to the vertical pipe system, which emulates a hose connection assembly of a standpipe system, and which comprises a control valve that is configured for connection to a fire hose and which comprises a manual valve actuator for manually controlling an amount of pressurized water in the vertical pipe system which is output from the control valve into a fire hose connected to the hose connection assembly.

2. The apparatus of claim 1, further comprising a rubber padding on a bottom surface of the support base.

3. The apparatus of claim 1, wherein the support base comprises at least two handles.

4. The apparatus of claim 1, wherein the support base comprises a water drain plug.

5. The apparatus of claim 1, wherein the support base comprises a plurality of support baffles, each support baffle having one end welded to bottom section of a vertical pipe riser, and another end welded to a respective sidewall of the support base.

6. The apparatus of claim 5, further comprising openings disposed between bottom portions of the support baffles and a bottom inner surface of the support base to allow water flow between different inner compartments of support base as defined by the plurality of support baffles.

7. The apparatus of claim 1, wherein vertical pipe system comprises an upper vertical pipe section which is disposed above the hose connection assembly, and which is configured to provide an air chamber which serves as a water hammer arrestor.

8. The apparatus of claim 7, wherein the upper vertical pipe section comprises a T-fitting which connects the upper vertical pipe section, the hose connection assembly, and a lower vertical pipe section in a T-shaped arrangement.

9. The apparatus of claim 1, wherein the vertical pipe system comprises (i) a first vertical pipe section fixedly connected to a bottom inner surface of the support base, and (ii) a second vertical pipe section coupled to the first vertical pipe section by a first T-fitting.

10. The apparatus of claim 9, wherein the first T-fitting comprises the water supply inlet.

11. A system, comprising:
a standpipe drill and training apparatus;
a water pump to pump pressurized water from a water source to the standpipe drill and training apparatus;
wherein the standpipe drill and training apparatus comprises:
a support base configured to configured to hold water to support the apparatus;
a vertical pipe system connected to the support base;
a water supply inlet connected to the vertical pipe system, which emulates a fire department connection to a standpipe system, and which is configured for connection to a fire hose to inject the pressurized water into the vertical pipe system; and
a hose connection assembly connected to the vertical pipe system, which emulates a hose connection assembly of a standpipe system, and which comprises a control valve that is configured for connection to a fire hose and which comprises a manual valve actuator for manually controlling an amount of pressurized water in the vertical pipe system which is output from the control valve into a fire hose connected to the hose connection assembly.

12. The system of claim 11, wherein the water pump and the water source are provided by a fire engine which includes the water pump and a water tank with stored water that is pumped operation of the water pump.

13. The system of claim 11, further comprising a rubber padding on a bottom surface of the support base of the standpipe drill and training apparatus.

14. The system of claim 11, wherein the support base of the standpipe drill and training apparatus comprises at least two handles and a water drain plug.

15. The system of claim 11, wherein the support base of the standpipe drill and training apparatus comprises a plurality of support baffles, each support baffle having one end welded to bottom section of a vertical pipe riser, and another end welded to a respective sidewall of the support base.

16. The system of claim 15, further comprising openings disposed between bottom portions of the support baffles and a bottom inner surface of the support base to allow water flow between different inner compartments of support base as defined by the plurality of support baffles.

17. The system of claim 11, wherein vertical pipe system of the standpipe drill and training apparatus comprises an upper vertical pipe section which is disposed above the hose connection assembly, and which is configured to provide an air chamber which serves as a water hammer arrestor.

18. The system of claim 17, wherein the upper vertical pipe section comprises a T-fitting which connects the upper vertical pipe section, the hose connection assembly, and a lower vertical pipe section in a T-shaped arrangement.

19. The system of claim 11, wherein the vertical pipe system of the standpipe drill and training apparatus comprises (i) a first vertical pipe section fixedly connected to a bottom inner surface of the support base, and (ii) a second vertical pipe section coupled to the first vertical pipe section by a first T-fitting.

20. The system of claim 19, wherein the first T-fitting comprises the water supply inlet.
